(19) United States
(12) Patent Application Publication
(10) Pub. No.: US 2017/0221388 A1
(43) Pub. Date: Aug. 3, 2017

(54) PASTING LABEL AND LAMINATED PRODUCT

(71) Applicant: FUJI XEROX CO., LTD., Tokyo (JP)

(72) Inventor: Kaoru TORIKOSHI, Kanagawa (JP)

(73) Assignee: FUJI XEROX CO., LTD., Tokyo (JP)

(21) Appl. No.: 15/200,921

(22) Filed: Jul. 1, 2016

(30) Foreign Application Priority Data
Jan. 29, 2016 (JP) 2016-016220

(51) Int. Cl. G09F 3/02; B32B 27/30; G09F 3/10; B32B 27/40

(52) U.S. Cl. CPC G09F 3/02; B32B 27/40; B32B 27/304; G09F 3/10; B32B 2307/412; B32B 2519/00; G09F 2003/0255

(57) ABSTRACT

A pasting label includes a peeling substrate, a pasting layer, an image supporting layer, an image receiving layer, and a transparent protective layer, in this order, wherein an image is provided between the image receiving layer and the image supporting layer and, with respect to an elongation at breaking strength (JIS K7161 (1994)), the transparent protective layer has a value of less than or equal to 100%, the image supporting layer has a value of from 120% to 500%, and the image receiving layer has a value of more than the value of the transparent protective layer and less than the value of the image supporting layer.

### CROSS-REFERENCE TO RELATED APPLICATIONS

This application is based on and claims priority under 35 USC 119 from Japanese Patent Application No. 2016-016220 filed Jan. 29, 2016.

### BACKGROUND

1. Technical Field

The present invention relates to a pasting label and a laminated product.

2. Related Art

Conventionally, as units for displaying information by fixing an image on a surface of an article, it is performed to paste a pasting label provided with an image.

### SUMMARY

According to an aspect of the invention, there is provided a pasting label including: a peeling substrate; a pasting layer; an image supporting layer; an image receiving layer; and a transparent protective layer in this order,

wherein an image is provided between the image receiving layer and the image supporting layer, and

wherein, with respect to an elongation at breaking strength (JIS K7161 (1994)), the transparent protective layer has a value of less than or equal to 100%, the image supporting layer has a value of from 120% to 500%, and the image receiving layer has a value of more than the value of the transparent protective layer and less than the value of the image supporting layer.

### BRIEF DESCRIPTION OF THE DRAWINGS

Exemplary embodiments of the present invention will be described in detail based on the following figures, wherein:

FIG. 1 is a cross-sectional view showing an example of a pasting label according to an exemplary embodiment;

FIG. 2 is a cross-sectional view showing an example of an image transfer sheet used in production of the pasting label according to an exemplary embodiment;

FIG. 3 is a cross-sectional view showing an example of a local substrate used in production of the pasting label according to an exemplary embodiment;

FIG. 4 is a cross-sectional view showing an example of a laminate laminated in which the image forming surface of the image transfer sheet having an image formed on the image receiving layer surface and a side surface of the image supporting layer of the label substrate are presented so as to face each other;

FIG. 5 is a cross-sectional view showing an example of a state in which the peeling substrate is peeled off from the pasting label according to the exemplary embodiment;

FIG. 6 is a cross-sectional view showing an example of a laminated product according to the exemplary embodiment; and

FIG. 7 is a schematic view showing an example of a configuration of a manufacturing apparatus of the pasting label according to the exemplary embodiment.

### DETAILED DESCRIPTION

Hereinafter, exemplary embodiments of the invention will be described in detail.

<Pasting Label>

A pasting label according to the exemplary embodiment has a peeling substrate, a pasting layer, an image supporting layer, an image receiving layer, and a transparent protective layer in this order. In addition, the pasting label has an image between the image receiving layer and the image supporting layer.

Then, with respect to an elongation at breaking strength, the transparent protective layer has a value of less than or equal to 100%, the image supporting layer has a value of from 120% to 500%, and the image receiving layer has a value of less than the value of the image supporting layer which exceeds the value of the transparent protective layer.

In addition, the elongation at the breaking strength is specified in (JIS K7161 (1994)), and the measurement temperature is set to 23° C.

A pasting label according to the exemplary embodiment is to provide the above configuration, and thus, the pasting label capable of preventing the image deformation may be provided.

An estimation mechanism by which this effect is exerted is presumed as follows.

Conventionally, it is conducted to paste a patch label having an image onto various members to be laminated, and, for example, it is conducted to fix an image on a surface to be laminated by peeling off the peeling substrate of a pasting label and pasting the pasting layer side of the pasting label onto the surface to be laminated of a member has been performed. In addition, as the surface to be laminated in which the pasting label is pasted, a variety of shapes such as a plane, a curved surface, an uneven surface, or the like is assumed. Therefore, excellent pasting performance for such a variety of the surfaces to be laminated is required.

On the other hand, in the case of pasting the pasting label onto a surface to be laminated such as a curved surface or an uneven surface, because it is required to be pasted to follow along with the surface shape, the curved portion of the curved surface and the corner portion in the uneven surface cause an elongation of the image in the pasting label, and thus image deformation such as cracking or image elongation may occur in the image. In addition, even in the case of pasting the pasting label onto the surface to be laminated of a plane that does not have a curved portion or a corner portion, pasting may be performed while stretching the pasting label or pasting may be performed while pressing an instrument such as a spatula, or the like so as not to allow bubbles to occur at the interface of the lamination (the interface between the pasting layer and the surface to be laminated). Therefore, the elongation of the pasting label also occurs and image deformation such as an image cracking, or the like may occur.

In the pasting label according to the exemplary embodiment, an image supporting layer, an image receiving layer, and a transparent protective layer are laminated in order from the pasting layer side to be pasted onto the surface to be laminated, and the structure of the label is that an image is formed between the image supporting layer and the image receiving layer. Accordingly, the elongation at breaking strength of the image supporting layer which is located nearest to the pasting layer side among these three layers is greater than those of the other two layers. Thus, when pasting onto the surface to be laminated, the image supporting layer tends to follow along with the surface shape of the surface to be laminated, and it is excellent in pasting performance. Therefore, even in the case of pasting onto a surface to be laminated such as a curved surface or an uneven surface, the image supporting layer is easily deformed along with the surface shape and pasting may be performed well. Further, even in the case of pasting while stretching a pasting label or pasting while pressing an instrument such as a spatula, the image supporting layer is easily deformed according to the given tension and pressure deformation, and thus, pasting may be performed well.

On the other hand, the elongation at breaking strength of the transparent protective layer which is the farthest away from the pasting layer side among these three layers is smaller than those of the other two layers, and elongation at breaking strength of the image receiving layer interposed between the image supporting layer and the transparent protective layer has a value between those of these two layers. Thus, when pasting is performed onto the surface to be laminated, the transparent protective layer which is the farthest away from the surface to be laminated is not easy to be deformed, and since the image receiving layer is supported on the transparent protective layer, deformation of the image receiving layer is also reduced. As a result, it is presumed that occurrence of image deformation such as an image cracking, or the like is prevented.

Elongation at Breaking Strength

Elongation at breaking strength in each layer (JIS K7161 (1994)) is as follows.

The elongation at breaking strength of the transparent protective layer is less than or equal to 100%, preferably less than or equal to 75%, and more preferably less than or equal to 50%. If the elongation at breaking strength of the transparent protective layer is in the above range, the occurrence of image deformation is prevented.

In the elongation at breaking strength, the image receiving layer has a value of more than the value of the transparent protective layer and less than the value of the image supporting layer. If the elongation exceeds the value of the transparent protective layer, the pasting performance for the surface to be laminated is excellent, and on the other hand, if the elongation should be less than the value of the image supporting layer, the occurrence of image deformation is prevented.

In addition, specifically, the elongation of the image receiving layer is preferably in the range of more than 100% and less than 120%.

The lower limit value of the elongation at breaking strength of the image supporting layer is more than or equal to 120%.

On the other hand, the upper limit of the elongation at breaking strength of the image supporting layer is less than or equal to 500%, and further preferably in the range of less than or equal to 300%. If the elongation at breaking strength of the image supporting layer is in the above range, the occurrence of the image deformation is prevented.

The elongation at breaking strength of the transparent protective layer, the image receiving layer and the image supporting layer may be controlled by the selection of materials in each layer, and may also be adjusted by the thickness of each layer.

Next, the configuration of the pasting label according to the exemplary embodiment will be described in detail.

The layer configuration of the pasting label according to the exemplary embodiment includes a peeling substrate, a pasting layer, an image supporting layer, an image receiving layer, and a transparent protective layer in this order.

Hereinafter, a configuration example of the pasting label of the exemplary embodiment will be described in detail with reference to the accompanying drawings. However, the configuration of the pasting label of the exemplary embodiment is not limited to the configuration shown below.

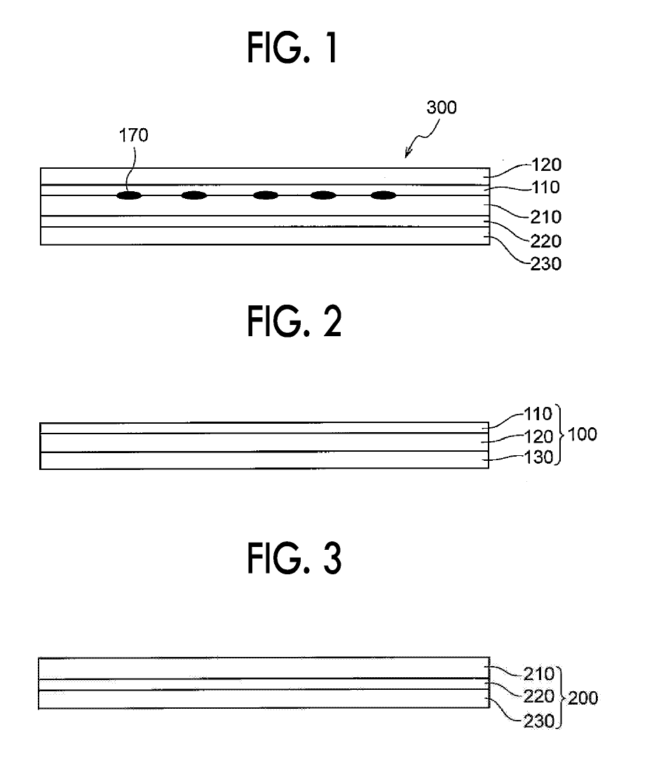

FIG. 1 is a schematic cross-sectional view showing an example of the pasting label of the exemplary embodiment. A pasting label 300 according to the exemplary embodiment shown in FIG. 1 includes a peeling substrate 230, a pasting layer 220, an image supporting layer 210, an image receiving layer 110, and a transparent protective layer 120. The pasting label has an image 170 between the image receiving layer 110 and the image supporting layer 210.

Further, the pasting label 300 accordingly to the exemplary embodiment which has an image 170 between the image receiving layer 110 and the image supporting layer 210 is not particularly limited, but for example, the pasting label may be prepared by using at least an image transfer sheet having a transparent protective layer and an image receiving layer and at least a label substrate having a peeling substrate, a pasting layer and an image supporting layer.

By way of example, for example, an image transfer sheet 100 is prepared in which a transparent protective layer 120 and an image receiving layer 110 are laminated on a sheet substrate 130 as shown in FIG. 2. Further, a label substrate 200 is prepared in which a pasting layer 220 and an image supporting layer 210 are laminated on a peeling substrate 230 as shown in FIG. 3.

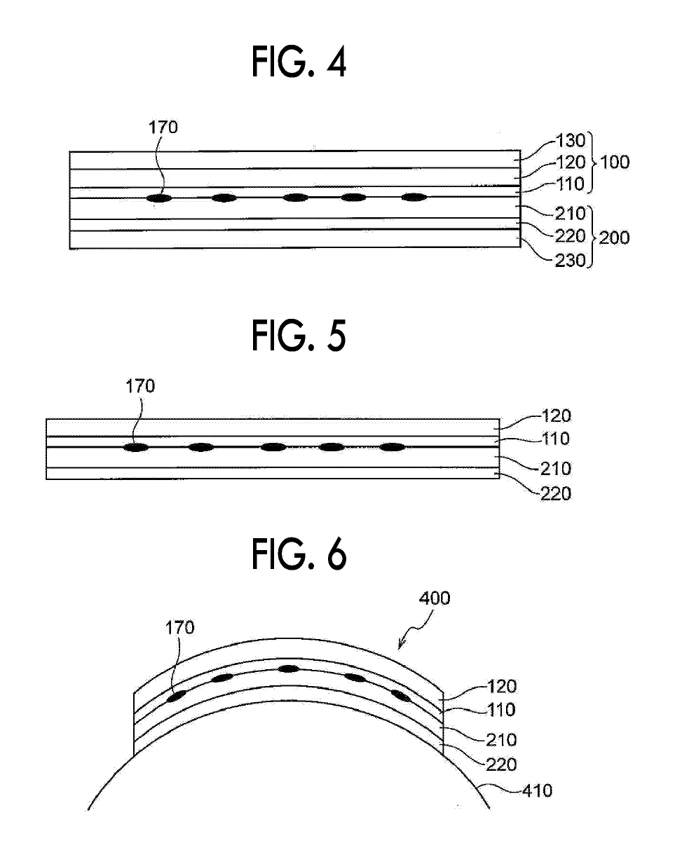

First, an image 170 is formed on the surface of the side of the image receiving layer 110 of the image transfer sheet 100 by, for example, an electrophotographic image forming method, or the like. Then, as shown in FIG. 4, a pasting label 300 shown in FIG. 1 is manufactured by laminating both of the forming surface of the image 170 of the image transfer sheet 100 (that is, the surface of the side of the image receiving layer 110) and the surface of the side of the image supporting layer 210 of the label substrate 200 so as to face each other to form a laminated member, adhering (laminating) the laminated member using heating and pressing, or the like, and then peeling off the sheet substrate 130.

In addition, a pasting label 300 according to the exemplary embodiment may be pasted to the member to be laminated having various surface shapes such as a plane, a curved surface or an uneven surface, and thus the label may fix the image on the surface of the member to be laminated. For example, in a case of pasting onto the member to be laminated having a curved surface shape, the image 170 is fixed on the surface of the member to be laminated 410 in, first, a state exposing the pasting layer 220 by peeling off the peeling substrate 230 as shown in FIG. 5, and then, by pasting the surface of the side of this pasting layer 220 for the curved surface of the member to be laminated 410 having a curved surface to obtain the laminated product 400 as shown in FIG. 6.

Then, a description of each layer constituting the pasting label of the exemplary embodiment is performed by describing each layer configuring the image transfer sheet and the label substrate used for the production of this pasting label.

Description of Image Transfer Sheet

(Image Receiving Layer)

The image receiving layer is a layer in which an image is formed on the surface thereof, and the layer is laminated and adhered (laminated) so as to face the image supporting layer of the label substrate. Further, the image receiving layer is preferably a layer having light transmittance from the viewpoint of facilitating the viewing of an image of a pasting label from the outside.

The image receiving layer may, for example, include a resin such as a thermoplastic resin and other compositions as needed.

Resin (Binder Component)

The image receiving layer provided on the surface of the image transfer sheet preferably includes a resin as a binder component, and preferably includes, for example, a thermoplastic resin.

The resin is not particularly limited as long as the elongation at breaking strength of the image receiving layer in the resin is capable of being controlled in the above-mentioned relationship, but for example, a polyester resin or a polyurethane resin is preferable.

As the polyester resin, in addition to the unmodified polyester resin, modified polyester resins such as silicone-modified polyester resins, urethane-modified polyester resins, or acrylic-modified polyester resins may also be used. Further, these polyester resins may be used alone or may be used in combination with two or more kinds thereof.

The polyester resin is manufactured, for example, by the reaction of a polyvalent hydroxy compound (polyol) and a polybasic carboxylic acid or its reactive acid derivative.

Examples of the polyvalent hydroxy compound constituting the polyester resin include diols such as ethylene glycol, diethylene glycol, triethylene glycol, 1,2-propylene glycol, 1,3-propylene glycol, neopentyl glycol, and 1,4-butanediol; bisphenol A alkylene oxide adducts such as hydrogenated bisphenol A, polyoxyethylenated bisphenol A, and polyoxypropylenated bisphenol A; other dihydric alcohols, dihydric phenols such as bisphenol A, or the like.

Further, as a polybasic carboxylic acid, for example, malonic acid, succinic acid, adipic acid, sebacic acid, alkyl succinic acid, maleic acid, fumaric acid, mesaconic acid, citraconic acid, itaconic acid, glutaconic acid, cyclohexane dicarboxylic acid, phthalic acid (isophthalic acid, terephthalic acid), other divalent carboxylic acids, or acid anhydrides thereof, alkyl esters, reactive acid derivative such as an acid halide, or the like are exemplified.

In addition to these divalent hydroxy compounds and carboxylic acid, trivalent or higher polyvalent hydroxyl compounds and trivalent or higher polybasic carboxylic acids may be added.

The polyurethane resin is a polymer having a urethane bond synthesized by polymerization of polyisocyanate with polyol. Further, since there are many types of polyurethane resins, those of thermosetting resins other than those of the thermoplastic resins may be used, or both may be used.

As the polyol component for synthesizing the polyurethane resin, acryl polyols, polyester polyols, polycarbonate polyols, or the like are exemplified, and among these, acrylic polyols are preferable from the viewpoint of heat resistance, lightfastness, degree of freedom in molecular design, or the like.

The acrylic polyol is obtained, for example, by a synthesis of an acrylic monomer having a hydroxyl group and, if necessary, an acrylic monomer having no hydroxyl group. As an acrylic monomer having a hydroxyl group, hydroxymethyl (meth)acrylate, hydroxyethyl (meth)acrylate, hydroxypropyl (meth)acrylate, hydroxybutyl (meth)acrylate, ethylenic monomers having a hydroxyl group such as N-methylol acryl amine, or the like may be used. Ethylenic monomers having a carboxyl group such as (meth)acrylic acid, crotonic acid, itaconic acid, fumaric acid, or maleic acid may also be used.

Further, examples of the monomer having no hydroxyl group include ethylenic monomers such as alkyl ester (meth) acrylate including methyl (meth)acrylate, ethyl (meth)acrylate, propyl (meth)acrylate, butyl (meth)acrylate, n-propyl (meth) acrylate, n-butyl (meth)acrylate, isobutyl (meth)acrylate, 2-ethylhexyl (meth)acrylate, n-octyl (meth) acrylate, n-dodecyl (meth)acrylate, or the like.

Synthesis of acrylic polyols may be performed by mixing the acrylic monomers and by performing ordinary radical polymerization or ionic polymerization, or the like.

As the polyisocyanate, for example, methylene diisocyanate, toluene diisocyanate, hexamethylene diisocyanate, isophorone diisocyanate, or the like are preferably used. In addition, diphenylmethane diisocyanate (MDI), naphthalene diisocyanate (NDI), dimethylphenyl diisocyanate (TODI), or the like may also be used. Polyisocyanates may be used alone or may be used as a mixture of two or more kinds thereof.

Further, besides, homopolymers or copolymers obtained by polymerizing one or two or more kinds of the following: styrenes such as styrene, vinyl styrene, or chlorostyrene; mono-olefins such as ethylene, propylene, butylene, or isobutylene; vinyl esters such as vinyl acetate, vinyl propionate, vinyl benzoate, or vinyl butyrate; esters of α-unsaturated fatty acid monocarboxylic acids such as methyl acrylate, ethyl acrylate, butyl acrylate, dodecyl acrylate, octyl acrylate, phenyl acrylate, methyl methacrylate, ethyl methacrylate, butyl methacrylate, or dodecyl methacrylate; vinyl ethers such as vinyl methyl ether, vinyl ethyl ether, or vinyl butyl either; vinyl ketones such as vinyl methyl ketone, vinyl hexyl ketone, vinyl isopropenyl ketone; dienic monomers such as isoprene, or 2-chloro butadiene, or the like may be exemplified.

Further, as the resin constituting the image receiving layer, a curable resin such as a thermosetting resin, a photocurable resin, or an electron beam curable resin may be configured.

As a resin, among these, a polyester resin and a polyurethane resin are preferable from the viewpoint of easily controlling the elongation at breaking strength of the image receiving layer in the above-described relationship.

The content (solid content ratio) of the resin in the image receiving layer is preferably from 60% by weight to 100% by weight, more preferably from 75% by weight to 95% by weight.

Further, it is preferable to contain a polyester resin and a polyurethane resin as a main component in the resin (binder component) contained in the image receiving layer from the viewpoint of easily controlling the elongation at breaking strength of the image receiving layer in the above-described relationship. Specifically, the ratio of the polyester resin and the polyurethane resin in the total resin (binder component) is preferably more than or equal to 50% by weight, more preferably more than or equal to 80% by weight, even more preferably more than or equal to 90% by weight, and particularly preferably equal to 100% by weight.

Releasing Agent

Further, the image receiving layer may contain a releasing agent such as a natural wax, a synthetic wax, a releasable resin, a reactive silicone compound or a modified silicone oil.

Specifically, a natural wax such as carnauba wax, beeswax, Montan wax, paraffin wax, or microcrystalline wax and low molecular weight polyethylene wax, low molecular weight oxidized polyethylene wax, low molecular weight polypropylene wax, low molecular weight oxidized polypropylene wax, higher fatty acid wax, higher fatty acid ester wax, or a synthetic wax such as Sasol wax, or the like is exemplified, and these waxes are not limited to a single use, but used several times by mixing.

In addition, as examples of the releasable resin, silicone resins, fluorine resins, or modified silicone resins which are modified products of silicone resins with various resins, for example, modified silicone resins such as polyester-modified silicone resins, urethane-modified silicone resins, acryl-modified silicone resins, polyimide-modified silicone resins, olefin-modified silicone resins, ether-modified silicone resins, alcohol-modified silicone resins, fluorine-modified silicone resins, amino-modified silicone resins, mercapto-modified silicone resins, or carboxy-modified silicone resins, thermosetting silicone resins, photo curable silicone resins, or the like may be added.

Further, in the exemplary embodiment, a reactive silane compound and modified silicone oil may be incorporated as a releasing agent.

Such a wax or a releasable resin may coexist in particulate states, but preferably used in a state of being incorporated in the resin by being added to the resin, then dispersing and dissolving it.

Filler

In addition, it is preferable to further use a filler in the image receiving layer.

The filler used in the exemplary embodiment is not limited, but in a case of those composed of organic resin particles, specifically, homopolymers or copolymers obtained by polymerizing one or more kinds of the following: styrenes such as styrene, vinyl styrene, or chlorostyrene; mono-olefins such as ethylene, propylene, butylene, or isobutylene; vinyl esters such as vinyl acetate, vinyl propionate, vinyl benzoate, or vinyl butyrate; esters of α-unsaturated fatty monocarboxylic acid such as methyl acrylate, ethyl acrylate, butyl acrylate, dodecyl acrylate, octyl acrylate, phenyl acrylate, methyl methacrylate, ethyl methacrylate, butyl methacrylate, or dodecyl methacrylate; vinyl ethers such as vinyl methyl ether, vinyl ethyl ether, or vinyl butyl ether; vinyl ketones such as vinyl methyl ketone, vinyl hexyl ketone, or vinyl isopropenyl ketone; dienic monomers such as isoprene, or 2-chloro butadiene, or the like may be exemplified.

Among them, styrenes, esters of α-unsaturated fatty acid monocarboxylic acid, or the like are preferable, and in a case of using these thermoplastic resins as a filler, it is preferable to coat these resins with a solvent which does not dissolve these resins. More preferably, thermosetting resins which have a cross-linking structure by adding a crosslinking agent to a thermosetting resin may be exemplified.

Further, if the filler includes inorganic particles, specific examples thereof include mica, talc, silica, calcium carbonate, zinc white, halloysite clay, kaolin, hydrochloric acid magnesium carbonate, quartz powder, titanium dioxide, barium sulfate, calcium sulfate, alumina, or the like.

As the filler, a bead-shaped plastic powder (for example, cross-linked PMMA, polycarbonate, polyethylene terephthalate, polystyrene) other than the above may be used.

The shape of the filler is generally spherical particles, but the shape may be plate, needle, or an uneven shape.

The volume average particle diameter of the filler is preferably from 0.1 μm and to 30 μm, and preferably 1.2 times or more of the thickness of the image receiving layer.

Weight ratio (filler:resin) of the filler and the resin (binder component) in the image receiving layer is preferably in the range of 0.01:100 to 15:100, and more preferably in the range of 0.5:100 to 5:100.

The thickness of the image receiving layer is preferably from 5 μm to 25 μm, and more preferably from 5 μm to 20 μm from the viewpoint of easily controlling the elongation at breaking strength of the image receiving layer in the above described relationship.

Here, the film thickness values of each layer described in the specification are those measured by DIGIMATIC INDICATOR ID-H0530 manufactured by Mitutoyo Corporation.

(Transparent Protective Layer)

The transparent protective layer is a layer capable of constituting the outermost surface in a pasting label. Further, the layer is preferably a layer having light transmittance in the viewpoint of facilitating the viewing of an image in a pasting label from the outside.

As the transparent protective layer, a plastic film is typically used. Among these, a polyacetate film which is a film with light transmittance used as an OHP film, a cellulose triacetate film, a nylon film, a polyethylene terephthalate (PET) film, a polyethylene naphthalate film, a polycarbonate film, a polysulfone film, a polystyrene film, a polyethylene sulfide film, a polyphenylene sulfide film, a polyphenylene ether film, a cycloolefin film, a polypropylene film, cellophane, an acrylonitrile-butadiene-styrene (ABS) resin film, or the like may be exemplified.

Among these, from the viewpoint of easily controlling the elongation at breaking strength of the transparent protective layer in the above mentioned range, a polyethylene terephthalate (PET) film, a polyethylene naphthalate film, a polyethylene sulfide film, or a polyphenylene sulfide film is preferable, and a polyethylene terephthalate (PET) film, a polyethylene naphthalate film, or a polyethylene sulfide film is more preferable.

The method for preparing a transparent protective layer is not particularly limited, but a known method such as a co-extrusion method, a adhering method, or the like is utilized.

In addition, as a general preparing method, after being co-extruded, a method of winding may be exemplified by entering the longitudinal stretching step, drawing the layer between two rolls or plural rolls in which the peripheral speeds are different, and adjusting the film thickness of the object. In the case of biaxial stretching, it is preferable to introduce the film passed through the above steps as it is into a tenter, and stretch the film 2.5 times to 5 times in the width direction. The preferable stretching temperature at this time is in the range of from 100° C. to 200° C.

The biaxially stretched film thus obtained is subjected to a heat treatment as required. The heat treatment is preferably carried out in a tenter, and in particular, if being heat-treated while relaxation in the transversal and longitudinal direction, the film having a low heat shrinkage ratio is obtained. A biaxially stretched film is particularly preferable as a transparent protective layer.

One side of the transparent protective layer is more preferably subjected to a releasing treatment.

Such a releasing treatment is generally performed to treat the surface of the releasable materials. The releasable materials are not particularly limited, but silicon materials are preferable. These silicon materials include a condensate resin containing at least a silane composition, those made of a mixed composition thereof with colloidal silica dispersion, or the like. Further, the silicon materials preferably contain an organic resin.

The silane composition specifically includes an organic silicon compound, the composition includes a silane compound, a fluorine-containing silane compound and an isocyanate silane compound, and a resin composition obtained by subjecting condensation reactions of these may be exemplified.

Examples of the silane compound include alkoxysilazanes such as Si(OCH₃)₄, CH₃Si(OCH₃)₃, HSi(OCH₃)₃, (CH₃)₂Si(OCH₃)₂, CH₃SiH(OCH₃)₂, C₆H₅Si(OCH₃)₃, Si(OC₂H₅)₄, CH₃Si(OC₂H₅)₃, (CH₃)₂Si(OC₂H₅)₂, H₂Si(OC₂H₅)₂, C₆H₅Si(OC₂H₅)₃, (CH₃)₂CHCH₂Si(OCH₃)₃, CH₃(CH₃)₁₁Si(OC₂H₅)₃, CH₃(CH₂)₁₅Si(OC₂H₅)₃, and CH₃(CH₂)₁₇Si(OC₂H₅)₃; silanes such as (CH₃)₃SiNHSi(CH₃)₃; special silylating agents such as ((CH₃)SiNH)₂CO, and tert-C₄H₉(CH₃)₂SiCl; silane coupling agents; silane compounds such as HSC₃H₆Si(OCH₃)₃; hydrolysates and partial condensates thereof, and the like.

Examples of the silane coupling agent include vinyl silanes such as vinyl tris(β-methoxyethoxy) silane, vinyl triethoxy silane, vinyl trimethoxy silane; acrylsilanes such as γ-methacryloxy propyl trimethoxy silane; epoxysilanes such as β-(3,4-epoxy cyclohexyl) ethyl trimethoxy silane, γ-glycidoxy propyl methyl diethoxysilane; aminosilanes such as N-β-(aminoethyl)-γ-aminopropyl methyl dimethoxy silane, γ-aminopropyl triethoxy silane, N-phenyl-γ-aminopropyl trimethoxy silane; and the like.

As the fluorine-containing silane compound, for example, fluorine-containing silane compounds such as CF₃(CH₂)₂Si(OCH₃)₃, C₆F₁₃C₂H₄Si(OCH₃)₃, C₇F₁₅CONH(CH₂)₃Si(OC₂H₅)₃, C₈F₁₇C₂H₄Si(OCH₃)₃, C₈F₁₇C₂H₄SiCH₃(OCH₃)₂, C₈F₁₇C₂H₄Si(ON═C(CH₃)(C₂H₅))₃, C₉F₁₉C₂H₄Si(OCH₃)₃, C₉F₁₉C₂H₄Si(NCO)₃, (NCO)₃SiC₂H₄C₆F₁₂C₂H₄Si(NCO)₃, C₉F₁₉C₂H₄Si(C₂H₅)(OCH₃)₂, (CH₃O)₃SiC₂H₄C₈F₁₆C₂H₄Si(OCH₃), (CH₃O)₂(CH₃)SiC₉F₁₈C₂H₄Si(CH₃(OCH₃)₂, hydrolysates or partial condensates thereof, or the like may be exemplified.

Examples of the isocyanate silane compound include (CH₃)₃SiNCO, (CH₃)₂Si(NCO)₂, CH₃Si(NCO)₃, vinyl silyltriisocyanate, C₆H₅Si(NCO)₃, Si(NCO)₄, C₂H₅OSi(NCO)₃, C₈H₁₇Si(NCO)₃, C₁₈H₃₇Si(NCO)₃, (NCO)₃SiC₂H₄(NCO)₃, or the like.

The condensate resins of the silane composition in the exemplary embodiment include, for example, curable silicone resins such as thermosetting silicone resins (condensation type, addition type) and photo-curable silicone resins, and specific examples thereof are as follows.

Examples of the condensation-type curable silicone resins among the thermosetting silicone resins include a curable silicone resin synthesized by using polysiloxanes such as polydimethylsiloxane having a silanol group at the terminal as a base polymer, by blending polymethyl hydrogen siloxane and the like as a crosslinking agent, and heating and condensing the blend in the presence of an organic acid metal salts such as organic tin catalysts or amines, a curable silicone resin synthesized by reacting polydiorganosiloxanes having reactive functional groups such as a hydroxyl group, an alkoxy group, or the like at the terminal, and further a polysiloxane resin synthesized by condensing silanols in which a trifunctional or higher chlorosilane or mixtures of these with mono-functional or di-functional chlorosilanes are hydrolyzed, or the like.

Further, the condensation types are morphologically classified into a solution type and an emulsion type, any of which are suitably used.

As the addition-type curable silicone resins among the thermosetting silicone resins, a curable silicone resin synthesized by using polysiloxanes such as polydimethyl siloxanes containing vinyl groups as the base polymer, blending the polydimethyl hydrodiene siloxane as a crosslinking agent, and reacting and curing the blend in the presence of a platinum catalyst, or the like is exemplified.

In addition, the addition types are morphologically classified into a solvent type, an emulsion type, and a solvent-free type, any of which are suitable used.

Examples of the thermosetting silicone resins obtained by curing the condensation type and the addition type suitably include, for example, pure silicone resins, silicone alkyd resins, silicone epoxy resins, silicone polyester resins, silicone acrylic resins, silicone phenol resins, silicone urethane resins, silicone melamine resins, or the like.

Examples of the photocurable silicone resins include a curable silicone resin synthesized by using a photo-cationic catalyst, a curable silicone resin synthesized by using a radical curing mechanism, and the like. In addition, a modified silicone resin is preferably used that is obtained by photocuring reaction of a low molecular weight polysiloxane having a hydroxyl group bonded to a silicon atom or an alkoxy group, or the like and alkyd resins, polyester resins, epoxy resins, acrylic resins, phenol resin, a polyurethane or a melamine resin, or the like. These resins may be used alone or may be used in a combination with two or more kinds thereof.

The thickness of the transparent protective layer is preferably from 2.0 μm to 50 μm, and more preferably from 3.0 μm to 25 μm from the viewpoint of easily controlling the elongation at breaking strength of the transparent protective layer in the aforementioned range.

(Sheet Substrate)

The sheet substrate is a layer which functions as a support member when forming an image on the surface of the image receiving layer in the image transfer sheet or when laminating and adhering (lamination of) the image transfer sheet and the label substrate, and also a layer which is peeled off and removed after being laminated with the label substrate.

The sheet substrate is not particularly limited, but for example, a plastic film is typically used. For example, a polyacetate film, a cellulose triacetate film, a nylon film, a polyethylene terephthalate (PET) film, a polyethylene naphthalate film, a polyester film, a polycarbonate film, a polysulfone film, a polystyrene film, a polyethylene sulfide film, a polyphenylene sulfide film, a polyphenylene ether film, a cycloolefine film, a polypropylene film, a polyimide film, cellophane, an (acrylonitrile-butadiene-styrene (ABS) resin film, or the like is preferably used, and further it may be opaque such as white, or the like.

Further, sheet materials such as paper, metal, plastic, ceramic, or the like are preferably used.

The thickness of the sheet substrate is preferably from 50 μm to 200 μm, and more preferably from 75 μm to 150 μm from the viewpoint of obtaining of the transportability in an image forming apparatus at the time of forming an image on an image transfer sheet, the fixing property at the time of fixing an image, and the laminating property when laminating the image transfer sheet and the label substrate.

(Adhesive Layer)

In the image transfer sheet according to the exemplary embodiment, the transparent protective layer and the sheet substrate may be formed via an adhesive layer.

The adhesive layer functions as an adhesive which physically joins the transparent protective layer and the sheet substrate together until the final step where the image transfer sheet is laminated onto the label substrate after an image is formed on the image transfer sheet, and functions to peel off the sheet substrate from the side of the transparent protective layer after it has been laminated.

The adhesive layer is made of a material of a semi-solid (that is, having viscosity) in an environment of normal temperature and normal pressure (23° C./50%). An adhesive layer capable of allowing other layers to adhere to each other while the state of the adhesive layer does not change, even after the junction is formed, and the adhesive layer itself does not solidify may be used. A material that is solid (that is, having no viscosity) in an environment of normal temperature and normal pressure (23° C./50%) may be used.

Examples of the material of the adhesive layer include a synthetic resin adhesive, a rubber adhesive, or the like. Examples of the synthetic resin adhesives include a silicone adhesive, an acrylic adhesive, a hot melt adhesive, or the like. Examples of the rubber adhesives include a natural rubber, a styrene-butadiene-rubber (SBR), a butyl rubber, or the like.

In addition, a synthetic resin adhesive which may adjust the peeling strength by the additives, or the like, is preferable, and further, among them, a silicone adhesive is more preferable from the viewpoint of temporal stability, heat resistance, or the like. However, it is not limited thereto from the context of such compatibility with the transparent protection layer.

(Physical Properties of the Image Transfer Sheet)

Surface Resistivity

In the image transfer sheet, the surface resistivity of the image receiving layer provided on the sheet substrate is preferably in the range of 1.0×10⁸ Ω to 3.2×10³³ Ω, and more preferably in the range of 1.0×10⁹ Ω to 1.0×10¹² Ω.

Further, the surface resistivity difference of front and back surfaces of the image transfer sheet at 23° C. and 55% RH is preferably with 4 digits, and more preferably within 3 digits.

The surface resistivity is measured in an environment of 23° C. and 55% RH, by using a circular electrode (for example, HIRESTA IP of “HR probe” manufactured by Mitsubishi Chemical Co., Ltd.) in accordance with JIS K6911.

In order to control the surface resistivity of the image receiving layer in the above range, it is preferable to incorporate a charge control agent in the image receiving layer. Further, the charge controlling agent may be added in the layer to be formed on the surface side opposite to the image receiving layer of the sheet substrate from the viewpoint of adjusting the surface resistivity of the surface side opposite to the image receiving layer of the image transfer sheet.

As the charge control agent, a polymeric conductive agent, a surfactant, conductive metal oxide particles, or the like is used.

Examples of the conductive metal oxide particles include ZnO, TiO, TiO₂, SnO₂, Al₂O₃, In₂O₃, SiO, SiO₂, MgO, BaO, MoO₃, or the like. These particles may be used alone or may be used in combination thereof. Further, the conductive metal oxide particles preferably further contain a different element, and for example, it is preferable to contain (dope) Al, In, or the like for ZnO, Nb, Ta, or the like for TiO, and Sb, Nb, halogen elements, or the like for SnO₂. Among these, SnO₂ doped with Sb is preferable, because its conductivity change is less over time and its stability is high.

Furthermore, from the viewpoint of controlling the surface resistivity of the image receiving layer in the above range, or from the viewpoint of transportability in the image transfer sheet (especially, transportability in the image forming apparatus), it is preferable to add a matting agent to the image receiving layer. In addition, from the viewpoint of adjusting the transportability of the surface side opposite to the image receiving layer in the image transfer sheet, the matting agent may be added in the layer which is formed on the surface side opposite to the image receiving layer in the sheet substrate.

As the matting agent, a resin having lubricating properties is preferable, and examples thereof include polyolefins such as polyethylene; fluorine resins such as polyvinyl fluoride, polyvinylidene fluoride, polytetrafluoroethylene (TEFLON (Registered Trademark)), and the like.

Examples of a method of controlling the surface resistivity of the surface side opposite to the image receiving layer in the image transfer sheet include a method of adding a surfactant, a polymer conductive agent, conductive particles, or the like in a sheet substrate, a method of coating a surfactant on one surface of the sheet substrate (the surface side opposite to the image receiving layer), a method of depositing a metal thin film on one surface of the sheet substrate, and the like.

As the surfactant used, for example, cationic surfactants such as polyamines, ammonium salts, sulfonium salts, phosphonium salts, betains, amphoteric salts, anionic surfactants such as alky phosphates, nonionic surfactants such as fatty acid esters and the like are exemplified. Among these surfactants, in the case of being used for electrophotography, it is preferable to use a cationic surfactant having a large interaction with a negatively charged toner for electrophotography.

In addition, among the above cationic surfactants, quaternary ammonium salts are preferable. As the quaternary ammonium salt, a compounds represented by the following formula (I) is preferable.

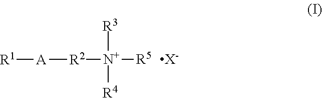

In the formula, R¹ represents an alkyl group, an alkenyl group, or an alkynyl group having 6 to 22 carbon atoms, R² represents a divalent group obtained by removing one hydrogen atom from an alkyl group, an alkenyl group, or an alkynyl group having 1 to 6 carbon atoms. R³, R⁴, and R⁵ may be the same or different, and represent an aliphatic group, an aromatic group, or a heterocyclic group. The aliphatic group may be a linear, branched or cyclic alkyl group, an alkenyl group, or an alkynyl group. The aromatic group represents a benzene monocyclic group, or a condensed polycyclic aryl group. These groups may have a substituent such as a hydroxyl group. A represents an amide bond, an either bond, an ester bond, or a divalent group obtained by removing one hydrogen atom from a phenyl group, but this may be omitted. X⁻ represents a halogen element, a sulfate ion, or a nitrate ion, and these ions may have a substituent.

Friction Coefficient

The static friction coefficient of the surface of the image transfer sheet is preferably less than or equal to 2, and more preferably less than or equal to 1. In addition, the dynamic friction coefficient of the surface of the image transfer sheet is preferably in the range of 0.2 to 1, and more preferably in the range of 0.3 to 0.65.

(Method of Preparing an Image Transfer Sheet)

Here, a method of preparing an image transfer sheet will be described with respect to an example of an image transfer sheet shown in FIG. 2. In the image transfer sheet shown in FIG. 2, the sheet substrate 130, the transparent protective layer 120, and the image receiving layer 110 are laminated, and the sheet substrate 130 and the transparent protective layer 120 are configured via an adhesive layer (not shown).

First, after applying the adhesive agent to be an adhesive layer onto the sheet substrate 130, an image transfer sheet may be formed by pasting the above mentioned films forming the transparent protective layer 120 and further applying the coating layer to be an image receiving layer 110 on the surface.

Further, apart from this procedure, an image transfer sheet may also be formed by applying the adhesive to be an adhesive layer onto the surface of the sheet substrate 130, after applying the coating layer to be an image receiving layer 110 on the surface of the above mentioned films forming the transparent protective layer 120, and by pasting the surface side of the adhesive layer in the sheet substrate 130 onto the surface side opposite to the image receiving layer 110 of the transparent protective layer 120.

The coating layer of the image receiving layer 110 may be formed by mixing each component such as resins, waxes, particles and the like using an organic solvent or a solvent such as water, or the like, dispersing the mixture by a device such as ultrasound, a wave rotor, an attritor, a sand mill, or the like to prepare a coating liquid, and applying and drying the coating liquid.

As a method of applying a coating liquid, commonly used methods such as a blade coating method, a wire bar coating method, a spray coating method, a dipping coating method, a bead coating method, an air knife coating method, a curtain coating method, a roll coating method, or the like are employed.

Drying may be done in air-drying, and may also be more easily dried by performing thermal drying. As the drying method, commonly used methods such as a method to put into an oven, a method to pass through an oven, or a method to contact the heat roller, or the like are employed.

Description of Label Substrate

(Image Supporting Layer)

The image supporting layer is a layer which is laminated and bonded (laminated) so as to face the image receiving layer of the image transfer sheet, and is a layer which sandwiches and holds the image between the image receiving layers.

As the image supporting layer, a resin film is typically used. Further, from the viewpoint of easily controlling the elongation at breaking strength of the image supporting layer in the above mentioned range, a polyurethane resin and a polyvinyl chloride (PVC) is preferable. By using a polyurethane resin film or a polyvinyl chloride (PVC) film, the elongation at breaking strength may be easily adjusted by the chemical structure and degree of crosslinking of the resin, the control of the added amount of plasticizers, or the like.

Further, the resin film as an image supporting layer may contain, for example, polyester resins and polyolefin resins in combination thereof, in addition to the above resins.

In addition, from the viewpoint of enhancement of the chromogenic property of the image, those of a pale color or a while color are preferable as the image supporting layer.

However, if the transparency is required as a pasting label, it is required to transmit the color of the surface of the member to be laminated, an image supporting layer having light transmittance should be used.

The thickness of the image supporting layer is preferably from 10 μm to 200 μm, and more preferably from 20 μm to 150 μm, from the viewpoint of easily controlling the elongation at breaking strength of the image supporting layer in the above mentioned range.

(Pasting Layer)

The pasting layer is a layer to be pasted in direct contact with the surface of a member to be laminated when pasting a pasting label onto the member to be laminated.

The pasting layer preferably contains an adhesive. Examples of the adhesive include an adhesive made of homopolymers or copolymers obtained by polymerizing one or two or more kinds of the following: esters of α-unsaturated fatty acid monocarboxylic acid such as methyl acrylate, ethyl acrylate, butyl acrylate, dodecyl acrylate, octyl acrylate, phenyl acrylate, methyl methacrylate, ethyl methacrylate, butyl methacrylate, or dodecyl methacrylate; styrenes such as styrene, vinyl styrene, or chlorostyrene; monoolefins such as ethylene, propylene, butylene, or isobutylene; vinyl esters such as vinyl acetate, vinyl propionate, vinyl benzoate, or vinyl butyrate; vinyl ethers such as vinyl methyl ether, vinyl ethyl ether, or vinyl butyl ether; vinyl ketones such as vinyl methyl ketone, vinyl hexyl ketone, or vinyl isopropenyl ketone; dienic monomers such as isoprene, or 2-chlorobutadiene, or the like. Further, polyesters such as an unmodified polyester resin, modified polyester resins such as silicone-modified, urethane-modified, or acrylic-modified resins may be also used. Furthermore, silicone, urethane, epoxy, melamine, urea, or rubber (chloroprene, styrene-butadiene, or nitrile) adhesives may be used.

In the formation of the pasting layer, the above-mentioned resins may be directly applied as they are, but the resin may be coated after being diluted with a solvent.

Examples of the solvent used for dilution include, for example, known solvents such as methyl ethyl ketone, toluene, xylene, cyclohexanone, SOLVESSO, ethyl acetate, isophorone propylene glycol monomethyl ether acetate, n-butyl cellosolve, t-butyl cellosolve, methanol, ethanol, propyl alcohol, or butanol, and these solvents may be used by mixing them.

However, if the transparency is required as a pasting label, it is required to transmit the color of the surface of the member to be laminated, a pasting layer having light transmittance should be used.

Further, the thickness of the pasting layer is not particularly limited, but it is preferably in the range of 0.5 μm to 100 μm, and more preferably in the range of 1 μm to 50 μm.

(Peeling Substrate)

The peeling substrate is a layer in which the peeling label pasted onto the member to be laminated is peeled and removed, and also a layer having a function of covering and protecting the pasting layer until this peeling is performed.

Examples of the peeling substrate include, for example, paper on which one surface has been subjected to a peeling treatment. In the case of using paper, paper having a basis weight of more than or equal to 100 g/m² is preferable from the viewpoint of waste paper.

In addition, resin films may also be used. Examples of the resin films include polyester, polycarbonate, polyarylate, polyethylene terephthalate (PET), polyolefins, mixtures thereof and copolymers thereof, and the like.

In addition, the thickness of the peeling substrate is not particularly limited.

Preparation of Pasting Label

The pasting label according to the exemplary embodiment is not particularly limited, but it may be, for example, prepared by using the above image transfer sheet and the label substrate.

By way of example, an image 170 is formed on the surface side of the image receiving layer 110 of the image transfer sheet 100 by preparing the image transfer sheet 100 shown in FIG. 2 and the label substrate 200 shown in FIG. 3 (Image forming step). Then, as shown in FIG. 4, a pasting label 300 shown in FIG. 1 is prepared by laminating both of the forming surface of the image 170 of the image transfer sheet 100 (that is, the surface side of the image receiving layer 110) and the surface side of the image supporting layer 210 of the label substrate 200 so as to face each other (overlay process), performing heat-pressing (laminated) on the laminated member (lamination step), and then peeling off the sheet substrate 130 (peeling step) thereafter.

In addition, the image forming process is performed, for example, by an electrophotographic image forming method using the toner. In the case of forming a toner image by an electrophotographic system, fixation of the toner image is preferably performed so that the temperature of the surface (image forming surface) of the image transfer sheet is the melting temperature of the toner or less. When considering the melting temperature of the normal toner, the surface temperature of the image transfer sheet is preferably less than or equal to 130° C., and more preferably less than or equal to 110° C.

The image formation on the image transfer sheet by the electrophotographic system will be described by way of example. First, an electric charge is given on the surface of the photosensitive member (image holding member) for electrophotography, and the obtained image information is exposed on the surface to form an electrostatic latent image corresponding to the exposure. Then, toner which is an image forming material is supplied to the electrostatic latent image of the photosensitive member surface from the developing device, and thus an electrostatic latent image is visualized and developed by the toner (toner image is formed). Further, the formed toner image is transferred to the surface on which the image receiving layer of the image transfer sheet is formed, and finally the toner image is fixed to the surface of the image receiving layer with heat or pressure, and then the image transfer sheet is discharged from the electrophotography apparatus.

In the exemplary embodiment, a method of forming an image on the surface of the image receiving layer may form an image other than the toner image by the electrophotographic image forming method. For example, a method using ink may be used, and in particular an image forming method such as an inkjet method may be used to form an image.

In addition, in the overlay process, the superposition of the image transfer sheet and the label substrate may be carried out by holding and aligning an image transfer sheet and the label substrate by hand, and after formation of the image onto the image transfer sheet, the image transfer sheet and the label substrate may be sequentially discharged and aligned on the collating unit, or the like.

The thermal press adhering method in the laminating step is not particularly limited, and conventionally known various lamination techniques and laminating apparatuses are both suitably adopted. Among these, it is preferable to use a heat press method which laminates by applying heat. For example, the pressing may be performed by using conventional lamination techniques and a laminating apparatus in which a laminate of the image transfer sheet and the label substrate is passed through the press-contact portion (nip portion) of a pair of heat rolls, which causes heat-melting and heat-fusing the both, thereby bonding the image transfer sheet to the label substrate.

In the laminated laminate, after the image forming material (e.g., toner) is cooled and solidified, the sheet substrate of the image transfer sheet is peeled off from the label substrate, the image forming material is transferred to the label substrate to record the image, and the pasting label according to the exemplary embodiment is obtained.

Further, the temperature of cooling and solidifying is specifically a temperature less than or equal to the softening point of which the image forming material such as toner solidifies, for example, less than or equal to the glass transition temperature of the image forming material, and preferably from room temperature (22° C.) to 50° C.

Here, a method of preparing a pasting label according to the exemplary embodiment will be described with reference to drawings.

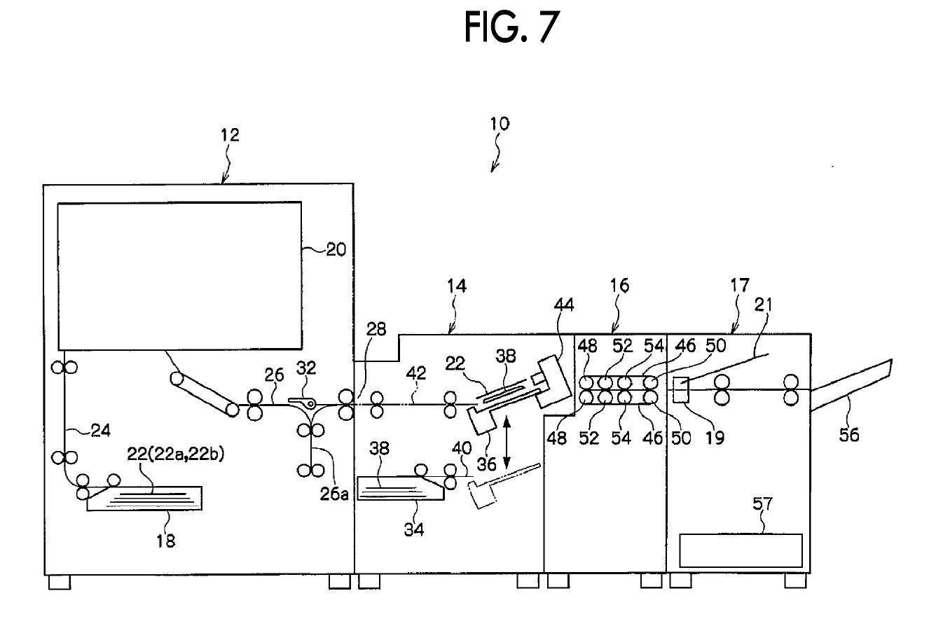

FIG. 7 is a schematic configuration diagram showing a preparing apparatus of the pasting label of the exemplary embodiment. The preparing apparatus 10 of the pasting label shown in FIG. 7 is composed of an image forming apparatus 12, a collating device 14 (positioning portion), a laminating apparatus 16 (thermal pres adhering portion), and a peeling device 17 (peeling part).

The image forming apparatus 12 is, for example, composed of an image transfer sheet storage unit 18, an image forming unit 20, a transport path 24 for conveying the image transfer sheet 22 from the image transfer sheet storage unit 18 to the image forming unit 20, and a transport path 26 for conveying the image transfer sheet 22 from the image forming unit 20 to the outlet 28. Other configurations are omitted.

In the image transfer sheet storage unit 18, the image transfer sheet 22 is accommodated, at the same time the pickup roll or the sheet feeding roll provided in the conventional sheet feeding apparatus is provided and the sheet feeding roll is rotated at a defined timing to transport the image transfer sheet 22 to the image forming unit 20.

The image forming unit 20 is not shown, but is configured of an apparatus according to the electrophotographic system including a latent image holding member, a charging unit for charging the latent image holding member, a latent image forming device for forming a latent image on the charged latent image holding member, a developing device for developing latent image using a developer containing at least toner and obtaining the toner image, a transferring device for transferring the developed toner image to the image transfer sheet 22, and a fixing device for heating and pressurizing the toner image transferred to the image transfer sheet 22 to fix it.

The transport paths 24 and 26 are configured of plural roller pairs and a guide (not shown) including a driving roller pair, and further in the transport path 26, a reversing path 26a to reverse the image transfer sheet 22 in the conveying direction by 180° is provided. A cam 32 for changing the guiding direction of the image transfer sheet 22 is provided in the branch portion of the transport path 26 and the reversing path 26a. By reciprocating the image transfer sheet 22 by the reversing path 26a and being returned to the transport path 26 again, the conveying direction of the image transfer sheet 22 is reversed by 180°, and at the same time, the front and back of the image transfer sheet 22 is inverted and transported.

The collating apparatus 14 is constituted by a label substrate storage unit 34, a collating unit 36 (positioning part), a transport path 40 for supplying the label substrate 38 from the label substrate storage unit 34 to the collating unit 36, and a transport path 42 for supplying the image transfer sheet 22 discharged from the outlet 28 of the image forming apparatus 12 to the collating unit 36.

A transport path 40 discharge unit for supplying a label substrate 38 to the collating unit 36, and a transport path 42 discharging unit for supplying the image transfer sheet 22 to the collating unit 36 are arranged in parallel in the height direction.

The transport paths 40 and 42 may be configured to include a plate member and conveying rolls for causing the image transfer sheet 22 or the label substrate 38 to be transported on a surface of the plate member, and also may be configured of a rotating belt-shaped carrier. Further, at the timing that the image transfer sheet 22 is discharged from the image forming apparatus 12 or the timing that the label substrate 38 is discharged, the conveying rolls or belts are rotated, and the image transfer sheet 22 or the label substrate 38 is transported to the collating unit 36.

In the label substrate storage unit 34, the label substrate 38 is accommodated, and at the same time the pickup roll or the sheet feeding roll provided in the conventional sheet feeding apparatus is provided, the sheet feeding roll, and the like are rotated after the collating unit 36 is moved to the position of the outlet of the label substrate storage unit 34, and the label substrate 38 is transported to the collating unit 36.

The collating unit 36 is configured so that the label substrate 38 and the image transfer sheet 22 are respectively supplied from the transport path 42 discharge unit and the transport path 40 discharge portion, for example, a portion of the ends of the collating unit is connected to the belt outer wall supported longitudinally (up and down in the drawing), and is also configured to be lifted along with the rotation driving of the belt.

The collating unit is not limited to the elevating units, and a known lifting units such as a motor drive system may also be applied. Further, positioning unit (not shown) for aligning the ends of the label substrate 38 and the image transfer sheet 22 that are laminated is provided.

In the collating unit 36, a tacking device 44 for temporarily fixing a laminate by laminating a label substrate 38 and the image transfer sheet 22 is provided. This tacking device, for example, includes a pair of projecting pieces made of metal to be heated by a heater, or the like, the end portion of the laminate is sandwiched by the heated one pair of projecting pieces, and the end portion of the laminate is heat welded and temporarily fixed.

A temporary fixing method is not limited to the method by the pair of projecting pieces as long as the heat welding is used, but other existing methods, namely a method in which a heated needle-shaped member is passed through the sheet in the longitudinal direction, and the sheet is sandwiched by the member equipped with the ultrasonic vibrator, and welding may be performed by heat generated by ultrasonic vibration may be used. Further, units that constrain the mechanical mutual movement without using heat, that is, grippers that may be fixed using a needle, or the like of a stapler, or may be moved together with the sheet along a transport path may be provided.

In the case where the tacking device 44 is provided in the transport path of the laminate from the collating unit 36 to the laminating apparatus 16, the tacking device 44 is located at the end portion of the collating unit 36 only at the time of temporary fastening, and thus at other times, it is necessary to take a structure capable of retracting from the transport path.

The laminating apparatus 16, for example, may adopt a belt nip system composed of a pair of belts 46. Each belt 46 is supported by a heat and pressure roll 48 and a support roll 50 and further has pressure rolls 52 and 54.

A pressing method used for the laminating apparatus 16 is not particularly limited, and conventionally known various lamination techniques and laminating apparatuses are both suitably adopted. For example, the pressing may be performed by using conventional lamination techniques, a laminating apparatus, a heat pressing technique and a heat pressing apparatus in which the laminate is passed through the nip portion with the pair of heat rolls to cause heat-melting and heat-fusing.

The peeling apparatus 17 includes, for example, an air blow-out nozzle 19 and a guide 21, and a discharge receiver 56 is provided downstream of the transporting path of the obtained pasting label.

Next, the operation of the preparing apparatus 10 of the pasting label will be described.

First, in the image forming apparatus 12, the image transfer sheet 22 is supplied to the image forming unit 20 through the transport path 24 from the image transfer sheet storage unit 18, and the toner image is transferred on the upper surface of the image transfer sheet 22 (the upper side in the drawing) according to the electrophotographic system, and a fixed image is formed (image forming step). Since the fixed image on the upper surface of the image transfer sheet 22 is formed, the image transfer sheet 22 passes through the transport path 26, via a reversing path 26a, is returned to the transport path 26 again, and is transported to the outlet 28. Therefore, the sheet is sent to the collating device 14.

In this case, in the branching portion of the transport path 26 and the reversing path 26a, the cam 32 is driven to overlap the leading end with the transport path 26, and the image transfer sheet 22 which has reached the end position of the cam 32 changes the reversing direction to be guided and transported to the reversing path 26a. Then, after the image transfer sheet 22 reaches the reversing path 26a, the driving roll (not shown) is reversed, and the image transfer sheet 22 is reciprocated in the reversing path 26a to be returned to the transport path 26 again. Therefore, in the image transfer sheet 22 which has returned to the transport path 26, the transporting direction is reversed by 180°, and at the same time, the front and back are also reversed so that the image plane is facing downward (the lower side in drawings).

Next, in the collating device 14, the collating unit 36 is moved (lowered) to the transport path 40 discharging unit, and the label substrate 38 is supplied to the collating unit 36 through the transport path 40 from the label substrate storage unit 34. Here, the label substrate 38 leaving the transport path 40 discharging unit is supplied to the collating unit 36 by its own weight. Further, the label substrate 38 is supplied to the collating unit 36 so that the image supporting layer side is facing upward. Thereafter, the collating unit 36 is moved (raised) to the transport path 42 discharging portion.

On the other hand, the image transfer sheet 22 transported to the collating device 14 is supplied to the collating unit 36 through the transport path 42 of the collating device 14. Here, the image transfer sheet 22 exiting the transport path 42 discharge unit is transported to the collating unit 36 by its own weight and is superposed with the label substrate 38 so that the image plane faces the lower surface.

Thus, in the collating unit 36, a label substrate 38 where an image supporting layer side is upward and an image transfer sheet 22 where an image surface is downward are overlaid (positioning step).

Then, the ends of the label substrate 38 on the collating unit 36 and the image transfer sheet 22 are aligned by the positioning unit (not shown), and then temporarily fixed to the ends of the laminate by the tacking device 44, and it is transported to the laminating apparatus 16. In addition, the positioning is performed by adjusting the sizes of the image transfer sheet 22 and the label substrate 38 to be the same and by aligning the ends of the laminate.

Then, in the laminating apparatus 16, the laminate of the label substrate 38 and the image transfer sheet 22 is passed between a pair of belts 46 (nip) to perform a heat pressing treatment (lamination process) of the laminate, and the label substrate 38 and the image transfer sheet 22 are heated and pressed (heat pressing process).

The heat-pressed laminate is then transported to the peeling device 17.

When the laminate tip reaches the air blow-out nozzle 19, the compressed air is injected from the nozzle. The end portion of the sheet substrate of the image transfer sheet 22 is lifted from the label substrate 38 in which the image receiving layer and the transparent protective layer are pressed, and the tip of the guide 21 enters the area sandwiched between the sheet substrate and the transparent protective layer of the image transfer sheet 22. Further, as the laminate is transported, the sheet substrate of the image transfer sheet is transported and peeled off in a direction of separating from the label substrate 38 along the guide 21. In this way, the pasting label is produced. The prepared pasting label is discharged to a discharge receiver 56.

The sheet substrate of the image transfer sheet 22 is discharged to the sheet substrate discharge receiver 57 through a path (not shown) thereafter.

As shown above, in the preparing apparatus of the pasting label of the exemplary embodiment, a pasting label is obtained by forming an image on the image receiving layer surface of the image transfer sheet 22 according to an electrophotographic system, facing the image surface and the surface of the image supporting layer side of the label substrate 38, heating and pressing them, and by peeling off the sheet substrate of the image transfer sheet.

<Laminated Products>

A pasting label according to the exemplary embodiment is pasted to the various member to be laminated. Then, the image may be fixed onto the surface to be laminated by pasting a pasting layer side of the pasting label from which the peeling substrate is peeled off onto the surface to be laminated of the member to be laminated

That is, by using the pasting label according to the exemplary embodiment, provided is a laminated product having the member, a pasting layer on the surface of the member, an image supporting layer, an image receiving layer, and a transparent protective layer in this order, and having an image between the image receiving layer and the image supporting layer in which the elongation (JIS K7161 (1994)) at breaking strength of the transparent protective layer, the image supporting layer and the image receiving layer each is in the above-mentioned range.

Specifically, in explanation with reference to drawings, for example, in the case of being pasted onto the members to be laminated having a surface of a curved shape, as shown in FIG. 5, in a state of exposing the pasting layer 220 by peeling off the peeling substrate 230, then as shown in FIG. 6, a laminated product 400 may be obtained by pasting the surface of the pasting layer 220 side with respect to the curved surface of the member to be laminated 410 having a curved surface, and the image 170 is fixed to the surface of the member to be laminated 410.

According to the exemplary embodiment, when making the laminated product, that is, at the time of pasting a pasting label to the member to be laminated, the occurrence of image deformation such as cracking and elongation of the image is prevented.

In addition, even for the surface to be laminated of a variety of shapes such as a flat surface, a curved surface, an uneven surface, or the like, laminated products that have excellent pasting performance and bond well may be obtained.

Moreover, in the case where the member to be laminated has a surface with a curved shape, for example, the curvature radius may be more than or equal to 1.0 mm, or may be from 1.0 mm to 10 mm.

As a general label film (label substrate), polyethylene terephthalate (PET) film has been widely used, however, it is not easy to paste on a curved surface in which the curvature radius is less than or equal to 10 mm, and with one pasting, the film may be peeled off from the curved surface due to the rigidity of the PET film. In contrast, according to the exemplary embodiment, even for the member to be laminated having a curved surface in this range, a laminated material may be obtained while preventing the image deformation and, being laminated well on the curved surface.

The member to be laminated in which a pasting label according to the exemplary embodiment is pasted is not particularly limited, and examples thereof include commercially or industrially used products such as surfaces having a curved surface, an uneven surface, or a corner used in indoors and outdoors such as a hanger, a package, a signboard, columnar advertising, a motorcycle oil tank, the outer surface of motor vehicles, a tool, a handgrip of a tool, a plastic or metal container, an outer wall of a residential building, indoor wall (wallpaper), or the like.

### EXAMPLES

Hereinafter, the invention will be described more in detail by examples, but the invention is not limited thereto. Further, in the following Examples and Comparative Examples, “part” means “part by weight” and “%” means “% by weight”.

### Example 1

### Preparation of Image Transfer Sheet for Electrophotography

<Preparation of Image Receiving Layer Coating Liquid A-1>

20 parts of a polyester resin (manufactured by Toyobo Co., Ltd.: BYRON 885) as a thermoplastic resin, 1 part of a surfactant (manufactured by NOF CORPORATION: ELEGAN 264WAX), 3 parts of cross-linked acrylic spherical particles (manufactured by Soken Chemical & Engineering Co., Ltd.: MX-1500, average particle diameter: 15 μm) as a filler, and 4 parts of CARNAUBA WAX dispersion (manufactured by BYK Japan KK; CERACOL601, solid content: 20%) are added in a solvent of 50 parts of methyl ethyl ketone and stirred sufficiently to prepare an image receiving layer coating liquid A-1.

<Preparation of Adhesive Layer Coating Liquid B-1>

20 parts of a silicone adhesive agent (manufactured by Momentive Performance Materials Inc.: XR37-B9204, solid concentration of 60%) and 0.2 parts of a cross-linking agent (manufactured by Momentive Performance Materials Inc.: XC93-B6144) are diluted with 20 parts of toluene and sufficiently stirred to prepare an adhesive layer coating liquid B-1.

<Preparation of Release Imparting Liquid C-1>

20 parts of a curable silicone resin (manufactured by Shin-Etsu Chemical Co., Ltd.: KS779H) and 0.2 parts of a curing agent (manufactured by Shin-Etsu Chemical Co., Ltd.: CAT PL-8) are diluted with 200 parts of a methyl ethyl ketone-toluene mixture (weight ratio=1:1), and sufficiently stirred to prepare a release imparting liquid C-1.

### <Preparation of Image Transfer Sheet 1>

The above adhesive layer coating liquid B-1 is applied on one side of biaxially stretched polyethylene terephthalate (manufactured by Toray Industries, Inc.: LUMIRROR T60, thickness of 75 μm) as a sheet substrate using a wire bar and dried for 2 minutes at 120° C. to form an adhesive layer having thickness of 25 μm.

The above release imparting liquid C-1 is applied on one side of biaxially stretched polyethylene terephthalate (manufactured by Toray Industries, Inc.: LUMIRROR F53, thickness of 3.5 μm) as a transparent protective layer using a wire bar and dried for 1 minute at 120° C. to form a release layer having thickness of 0.1 μm.

The surface of the adhesive layer side of the sheet substrate is bonded on the surface where a release layer of the transparent protective layer is formed, at an ambient temperate (22° C.), under the conditions of a laminating rate of 0.2 m/minute and a cylinder pressure of 588 KPa.

Then, the above image receiving layer coating liquid A-1 is applied on the surface of the transparent protective layer side of the laminated material using a wire bar and dried for 1 minute at 120° C. to form an image receiving layer having a thickness of 10 μm. Then, the layer is cut into A4 size (210 mm×297 mm) to prepare an image transfer sheet 1 having a total thickness of 110 μm.

Surface resistivity of the image receiving layer side of the image transfer sheet 1 is 3.5×10¹⁰ Ω/square.

<Formation of the Image>

The image transfer sheet 1 (image unformed) is set in the manual sheet feeding device of an image forming apparatus (manufactured by Fuji Xerox Co., Ltd. color Multifunction Printer: DOCUCOLOR 1450GA), and a color mirror image including a solid image made of respective colors of cyan C, magenta M, yellow Y, and black K is formed on the image receiving layer surface in the A4 size.

(Performance Evaluation 1)

Evaluation of Transportability Within Apparatus

In the image forming, transportability of the image transfer sheet 1 in the image forming apparatus (running property at the time of transport) is evaluated as follows.

30 Sheets of the image transfer sheet 1 are set in the manual sheet feeding device of the above image forming apparatus and printing work is continuously performed on 30 sheets, and evaluation of transportability within apparatus is performed by the number of occurrences of double feeding (the phenomenon in which two or more sheets of the image transfer sheets are overlapped and transported) and the number of transport stops (jam) due to the image transfer sheet in the apparatus.

The evaluation criteria are as follows. If the number of occurrences is zero, then it is set to be “A”, if at least one of double feeding and jam occurs once, then it is set to be “B”, and if at least one of double feeding and jam occurs twice or more, then it is set to be “C”.

Fixing Property Evaluation

The commercially available cellophane adhesive tape having a width of 18 mm (manufactured by Nichiban Co., Ltd.: CELLOPHANE TAPE) is pasted in a line pressure of 300 g/cm on the solid image portion in which the image density (the ratio of the reflected light relative to the amount of the irradiated light measured by X-Rite 967 densitometer) of the image fixed on the surface of the image transfer sheet 1 in the above image apparatus is 1.8, and then the tape is peeled off at a speed of 10 mm/sec. Fixing property is evaluated by a ratio of the image density after peeling to the image density before peeling (the image density after peeling/the image density before peeling, hereinafter referred to as “OD ratio”) as an index.

Further, with respect to the recording medium for electrophotography, the toner fixing property whose OD ratio is 0.8 or more is generally required. In this evaluation, when the OD ratio is more than or equal to 0.9, then it is set to be “A”, when the OD ratio is more than or equal to 0.8 and less than 0.9, then it is set to be “B”, and when the OD ratio is less than 0.8, it is set to be “C”.

Image Density and Image Quality Evaluation

In the image density evaluation, a solid image portion is measured by X-Rite 967 densitometer (manufactured by X-Rite Co.). When the image density is more than or equal to 1.5, then it is set to be “A”, when the image density is 1.3 to 1.5, it is set to be “B”, and when the image density is less than 1.3, it is set to be “C”.

Further, in the image quality evaluation, when images are output under a high temperature and high humidity condition (28° C., 80% RH), at room temperature conditions (23° C., 50% RH), and at low temperature and low humidity (15° C., 15% RH), the exact printing properties (print reproducibility) of characters are evaluated. When the prints are reproduced in any condition, it is set to be “A”, and when it is confirmed that no print is visually reproduced, it is set to be “B”.

<Preparation of Label Substrate>

An acrylic adhesive (manufactured by Toagosei co., Ltd., product name: S-1605) is applied on one surface of a urethane film (manufactured by Dainichiseika Color & Chemicals Mfg. Co., Ltd., product name: P-1288, thickness of 50 μm) as an image supporting layer in thickness of 25 μm to form a pasting layer.

Then, the surface of the release-treated side of the release sheet (which the release treatment has been performed on one side of a paper having a basis weight of 125 g/m²) as a peeling substrate is superimposed and pasted on the surface of the pasting layer side to prepare a label substrate 1.

<Preparation of the Pasting Label>

The image surface of the image transfer sheet 1 is superimposed and laminated on the surface of the image supporting layer side of the obtained label substrate 1 using laminator (manufactured by Fujipura Co., Ltd.: LAMIPACKER LPD3226) under the conditions of a temperature of 150° C. and a feed rate of 0.4 m/min. Then, the sheet substrate (biaxially stretched polyethylene terephthalate, manufactured by Toray Industries, Inc.: LUMIRROR T60, thickness of 75 μm) of the image transfer sheet 1 is peeled off together with the adhesive layer to prepare a pasting label 1 in which an image, an image receiving layer, and a transparent protective layer are formed in this order on the label substrate.

(Performance Evaluation 2)

Laminating Property

For the laminating property evaluation, the surface of the transparent protective layer side of the pasting label 1 is cut into lattice-shaped lined squares each having a width of 2 mm with a cutter knife, a commercially available cellophane adhesive tape having a width of 18 mm (manufactured by Nichiban Co., Ltd.: CELLOPHANE TAPE) is pasted in a line pressure of 300 g/cm thereon, and then the tape is peeled off at a speed of 10 mm/sec to evaluate the laminating property based on the state after peeling.

When the transparent protective layer, the image receiving layer and the image are not all peeled, then it is rated as “A”, when a part of the transparent protective layer is peeled off, then it is rated as “B”, and when the image is peeled off, then it is rated as “C”.

(Measurement of Elongation at Breaking Strength)

With respect to the transparent protective layer, the image receiving layer, and the image supporting layer, the elongation thereof is measured by a method defined in (JIS K7161 (1994)). Measurement is conducted under the conditions of MD direction, a width of 10 mm, 200 mm/min, a chuck interval of 100 mm, a measuring temperature of 23° C., and a measuring humidity of 50% RH.

(Performance Evaluation 3)

Evaluation of Pasting to Curved Surface

As the member to be laminated, a hanger which has a curved surface with a curvature radius of 1.2 mm and the surface is made of vinyl chloride material is prepared. Then, the peeling substrate of the pasting label 1 is peeled off, and the pasting label 1 is pasted onto the curved surface of the member to be laminated in a line pressure of 100 g/cm to obtain a laminated material.

Followability to Curved Surface

Followability in pasting the pasting label 1 to the curved surface is evaluated by the following criteria.
A: pasting is performed in the same curvature radius as the curvature radius of the curved surface
B: Bending does not occur to the curvature radius of the curved surface, and pasting to the curved surface is not performed well.

Image Deformability

Further, the image in the laminated product, after the pasting label 1 is pasted thereto, is observed and evaluated by the following criteria.
A: There are no defects in the image deformation in which image cracks occur
B: There are defects in the image deformation in which image cracks in only a part of the image occur
C: There are defects in the image deformation in which image cracks in the entire image occur

### Example 2

The pasting label and the laminated product are prepared and evaluated in the same manner as in Example 1, except for changing the label substrate 1 in Example 1 to the label substrate 2 obtained by the following.

<Preparation of Label Substrate>

An acrylic adhesive (manufactured by Taisei Fine Chemical Co., Ltd., product name: 1LO-458) is applied on one side of a polyvinyl chloride (PVC) film (manufactured by Shin-Etsu Polymer Co., Ltd., product name: EX-455E, thickness of 50 μm) as an image supporting layer in a thickness of 30 μm to form a pasting layer.

Then, the surface of the release-treated side of the release paper (which the release treatment has been performed on one side of a paper having a basis weight of 120 g/m²) as a peeling substrate is superimposed and pasted on the surface of the pasting layer side to prepare a label substrate 2.

### Comparative Example 1

An image is applied directly on the surface of the image supporting layer of the label substrate 1 prepared in Example 1 by screen printing. Further, this product is used as a pasting label to prepare a laminated product in the same manner as in Example 1, and the above-described performance evaluation 2 and performance evaluation 3 are carried out as well.

### Comparative Example 2

An image is applied directly on the surface of the image supporting layer of the label substrate 2 prepared in Example 2 by screen printing. Further, this product is used as a pasting label to prepare a laminated product in the same manner as in Example 1, and the above-described performance evaluation 2 and performance evaluation 3 are carried out as well.

### Comparative Example 3

The pasting label and the laminated product are prepared and evaluated in the same manner as in Example 1, except for changing the transparent protective layer in Example 1 to an urethane resin (manufactured by Shin-Etsu Polymer co., Ltd., product name: EW-800, thickness of 40 μm).

### Comparative Example 4

The pasting label and the laminated product is prepared and evaluated in the same manner as in Example 1, except for changing the label substrate 1 in Example 1 to the label substrate 3 obtained by the following.

<Preparation of Label Substrate 3>

An acrylic adhesive (manufactured by Taisei Fine Chemical Co., Ltd., product name: 1LO-449) is applied On one side of a polyethylene terephthalate (PET) film (manufactured by Toray Industries, Inc., product name: LUMIRROR T60, thickness of 75 μm) as an image supporting layer in a thickness of 25 μm to form a pasting layer.

Then, the surface of the release-treated side of the release paper (which the release treatment has been performed on one side of a paper having a basis weight of 150 g/m²) as a peeling substrate is superimposed and pasted on the surface of the pasting layer side to prepare a label substrate 3.

The results of the performance evaluation 1 and the performance evaluation 2 are shown in Table 1 below.

TABLE 1

| | Transport- | Fixing | Image | Image | Laminating |
|---|---|---|---|---|---|
| | ability | property | density | quality | property |
| Example 1 | A | A | A | A | A |
| Example 2 | A | A | A | A | A |
| Comparative | (Not conducted) | | | | |
| Example 1 | | | | | |
| Comparative | (Not conducted) | | | | |
| Example 2 | | | | | |
| Comparative | B | A | A | A | A |
| Example 3 | | | | | |
| Comparative | A | A | A | A | B |
| Example 4 | | | | | |

In addition, the measurement results of elongation at breaking strength and the results of (performance evaluation 3/followability to the curved surface and image deformability) are shown in Table 2 below.

TABLE 2

| | | | | Evaluation | |
|---|---|---|---|---|---|
| | Elongation [%] | | | Follow- | |
| | Transparent | Image | Image | ability to | Image |
| | protective | receiving | supporting | the curved | deform- |
| | layer | layer | layer | surface | ability |
| Example 1 | 90 | 115 | 270 | A | A |
| Example 2 | 90 | 115 | 130 | A | A |
| Comparative | (None) | (None) | 270 | A | C |
| Example 1 | | | | | |
| Comparative | (None) | (None) | 130 | A | C |
| Example 2 | | | | | |
| Comparative | 550 | 115 | 270 | A | C |
| Example 3 | | | | | |
| Comparative | 90 | 115 | 85 | B | B |
| Example 4 | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A pasting label comprising: a peeling substrate; a pasting layer; an image supporting layer; an image receiving layer; and a transparent protective layer in this order,
wherein an image is provided between the image receiving layer and the image supporting layer, and
wherein, with respect to an elongation at breaking strength (JIS K7161 (1994)), the transparent protective layer has a value of less than or equal to 100%, the image supporting layer has a value of from 120% to 500%, and the image receiving layer has a value of more than the value of the transparent protective layer and less than the value of the image supporting layer.

2. The pasting label according to claim 1,
wherein a surface resistivity of the image receiving layer is in a range of from 1.0×10⁸ Ω to 3.2×10¹³ Ω.

3. The pasting label according to claim 1,
wherein the image receiving layer includes a surfactant.

4. The pasting label according to claim 1,
wherein the image supporting layer is a polyurethane resin or polyvinyl chloride.

5. The pasting label according to claim 1,
wherein the image is a toner image.

6. A laminated product comprising:
a member having a curvature radius of 1.0 mm or more; a pasting layer, an image supporting layer, an image receiving layer, and a transparent protective layer in this order on the curved surface of the member; and an image between the image receiving layer and the image supporting layer,
wherein, with respect to an elongation at breaking strength (JIS K7161 (1994)), the transparent protective layer has a value of less than or equal to 100%, the image supporting layer has a value of from 120% to 500%, and the image receiving layer has a value of more than the value of the transparent protective layer and less than the value of the image supporting layer.
